(19) United States
(12) Patent Application Publication
(10) Pub. No.: US 2026/0080650 A1
(43) Pub. Date: Mar. 19, 2026

(54) BULLET CASING IMAGE ALIGNMENT AND FORENSIC ANALYSIS SYSTEM USING THE SAME

(71) Applicant: iBallistix, Inc., Woodinville, WA (US)

(72) Inventors: David Olsen, Fremont, CA (US); Jonathan Kruljac, Kenmore, WA (US); Robert H. Poole, Annapolis, MD (US)

(21) Appl. No.: 18/998,399

(22) PCT Filed: Jul. 24, 2023
(86) PCT No.: PCT/US2023/028483

§ 371 Date: Jan. 24, 2025

Related U.S. Application Data
(60) Provisional application No. 63/392,034, filed on Jul. 25, 2022.

(51) Int. Cl. G06V 10/24; G06T 3/60; G06T 7/60; G06T 7/73; G06V 10/77; G06V 10/82

(52) U.S. Cl. CPC G06V 10/242; G06T 3/60; G06T 7/60; G06T 7/73; G06V 10/7715; G06V 10/82; G06T 2207/20081; G06T 2207/20084

(57) ABSTRACT

Methods, systems, and apparatus, including computer programs encoded on a computer storage medium, for automatic digital image rotation are disclosed. A method includes obtaining an image of a head of a firearm cartridge casing; identifying, in the image of the head of the firearm cartridge casing, one or more markings on the head of the firearm cartridge casing; determining, using the identified one or more markings, an orientation of the firearm cartridge casing in the image; determining a target orientation of the firearm cartridge casing; and rotating the image of the firearm cartridge casing to align the orientation of the firearm cartridge casing in the image with the target orientation. The one or more markings include at least one of scratch marks, shear marks, and drag marks. The one or more markings include a breechface pattern.

### CROSS-REFERENCE TO RELATED APPLICATION

This application claims priority to U.S. Provisional Application No. 63/392,034, filed on Jul. 25, 2022, the entirety of which is incorporated herein.

### BACKGROUND

Current systems for collecting and analyzing forensic evidence associated with gun-related crimes and injuries include sending collected forensic evidence, e.g., bullets and bullet cartridge casings, to an off-site central processing location. Forensic scientists at the central processing location generate a forensics report from ballistic imaging of the evidence and comparisons to a database including manufacturer's markings on components of guns that serve as identifying features. Generated reports by off-site central processing locations can cause delays in active investigations due to the transit time of the forensic evidence to the central processing location, limited imaging and personnel resources, and a backlog of cases from nationwide sources.

Toolmark identification is a discipline of forensic science which has as its primary concern to determine if a toolmark was produced by a particular tool. Firearm identification is a sub-category of toolmark identification; which has as its primary concern to determine if a bullet, cartridge case, or other ammunition component was fired by a particular firearm.

Firearm and toolmark identification is possible because the surfaces of a fabricated item, such as a firing pin, breach block or a barrel, will, as a result of manufacturing, have tiny imperfections and irregularities at the microscopic level even when manufactured to rigorous specifications. These microscopic dents, burrs, and other minute blemishes are transferred to different parts of the ammunition and are what allows the toolmark examiner to establish a link between the firearm and ammunition.

It is common for toolmark examiners to orient cartridge casings such that the striations (i.e., scratches or imprint marks) on the shell surface run along a single axis, for example, horizontally, left to right, with a reference point anchoring which side is left and which side is right. To do this, a toolmark examiner manually pre-rotates the cartridge casings before scanning them so that the firing pin aperture impression aligns horizontally. Typically, this can include aligning with the firing pin aperture shear marks oriented at 9 o'clock if visible and the drag mark aligned at the 3 o'clock position if available.

Cartridge casings must be aligned correctly in both optical and electronic comparison tools. Thus, it is incumbent upon the operator of either type of tool to ensure that the cartridge casings are well-aligned prior to inspection or running scans. This process takes time, effort, and expertise gained through specialized forensic training. Improper alignment of the cartridge casings manifests negatively on the forensic matching, resulting in a poor matching correlation. These errors could mean the difference between a criminal being caught or getting away with a crime.

### SUMMARY

Implementations of the present disclosure are generally directed to systems and methods that employ computer vision techniques, including artificial intelligence, to automatically align and analyze cartridge casings (also referred to as “bullet cartridge casings,” “shell casings,” or “bullet shell casings”) that have been scanned by a forensic imaging apparatus, e.g., a field-deploy able scanning unit. The disclosed techniques can be used to align cartridge casings scanned at any orientation with respect to a camera of the forensic evidence imaging apparatus, e.g., a field-deployable scanning unit. The disclosed techniques include computer implemented methods for perform the automatic alignment of digital images of cartridge casings, in order to enable the comparison of multiple different images of cartridge casings.

Automatic digital image rotation can be performed in part using digital signal processing algorithms. Autorotation can be applied to cartridge casings with any arbitrary imprint patterns. In some implementations, the disclosed techniques can be used to align shell images while following the same general alignment guidelines that human operators use to align cartridge casings. For example, the system can automatically align images of cartridge casings so that scratch patterns have a horizontal orientation (e.g., or an orientation in any other specified direction) with respect to a set of reference axes. The system can also accommodate any orientation angle, standard, or convention. For example, the system can be implemented to rotate shell images to align markings of the cartridge casing with any specified angle.

Among other uses, the disclosed techniques and devices can be used to aid law enforcement in matching recovered cartridge casings from multiple crime scenes to dramatically improve the lead-generation process available today and ultimately facilitate successful prosecution of criminals. Other applications of the disclosed techniques and devices can include, for example, valuation and counterfeit detection of specimens including specularly reflective and faceted surfaces, e.g., rare coins, jewelry, and the like.

Implementations of the present disclosure are generally directed to an adaptive kit for in-field, real-time documentation, forensic analysis, and reporting of spent bullet shell casings. More particularly, the adaptive kit can be affixed or otherwise connected wirelessly to a smart phone, tablet, or other user device including an internal camera. The adaptive kit can include an illumination module with a set of light sources, e.g., LEDs, a set of diffusers, or the like, arranged with respect to a sample holder within the adaptive kit to generate photometric conditions for imaging a sample casing. The adaptive kit can, in some examples, couple the light directly from the smart phone or tablet's flash to illuminate the sample casing instead of relying on separate light sources, e.g., LEDs. The adaptive kit further includes a sample holder with a mounting mechanism to retain the sample casing while minimizing contact/contamination of the casing and which positions the sample casing at an imaging position. The adaptive kit further can include a macro lens for generating high resolution imaging conditions, e.g., 12-megapixel resolution (3-5-micron resolution) images.

In some examples, the adaptive kit can be a stand-alone portable device including illumination and imaging capabilities described herein. The stand-alone portable device may communicate with a user device, e.g., via wireless communication, to upload captured images to the user device.

The adaptive kit in combination with image processing software can be utilized to capture and process imaging data of a forensic sample, e.g., a spent bullet cartridge casing, where one or more surfaces of the bullet casing can be imaged under multiple imaging conditions, e.g., illumination at various angles and using different illumination sources. The captured imaging data can be processed to identify and catalogue tool marks, e.g., striation patterns including breech face marking, firing pin aperture impression markings, ejection marking and/or additional tool marks that may not be routinely utilized for identification. The processed imaging data can be utilized to generate metadata for the forensic sample which can be combined with additional metadata, e.g., GPS coordinates, crime scene details, etc. A database of catalogued forensic samples can be generated including the metadata for each forensic sample of multiple forensic samples. In some examples, metadata for each forensic sample can include information identifying an evidence collecting agent or officer, date and time of evidence recovery, location of evidence recovery (e.g., longitude/latitude), physical location of recovered evidence relative to a crime scene, and/or an indication on an electronic map interface (e.g., map “pin”) of a location of the recovered evidence. Additionally, photographs of the crime scene including photographs capturing location of the evidence can be included in the captured metadata for the forensic sample.

In general, one innovative aspect of the subject matter described in this specification can be embodied a method including actions of obtaining an image of a head of a firearm cartridge casing; identifying, in the image of the head of the firearm cartridge casing, one or more markings on the head of the firearm cartridge casing; determining, using the identified one or more markings, an orientation of the firearm cartridge casing in the image; determining a target orientation of the firearm cartridge casing; and rotating the image of the firearm cartridge casing to align the orientation of the firearm cartridge casing in the image with the target orientation.

In general, one innovative aspect of the subject matter described in this specification can be embodied in a method including actions of arranging a head of a firearm cartridge casing relative to a camera of a user device for the camera to acquire images of the head of the firearm cartridge casing; acquiring, with the camera, an image of the head of the firearm cartridge casing; determining an orientation of the firearm cartridge casing in the image; determining a target orientation of the firearm cartridge casing; and rotating the image of the firearm cartridge casing to align the orientation of the firearm cartridge casing in the image with the target orientation.

These and other examples can each optionally include one or more of the following features. In some examples, the one or more markings comprise at least one of scratch marks, shear marks, and drag marks.

In some examples, the one or more markings comprise a breechface pattern.

In some examples, the breechface pattern comprises one of a parallel pattern, a smooth pattern, a granular pattern, a cross-hatch pattern, a circular pattern, and an arched pattern.

In some examples, determining an orientation of the firearm cartridge casing in the image comprises providing the image to a model trained to determine the orientation of firearm cartridge casings in images.

In some examples, the model comprises a neural network model.

In some examples, the image of the head of the firearm cartridge casing is captured by a camera of a user device with the firearm cartridge casing head being in a fixed position relative to the camera of the user device.

In some examples, determining the target orientation of the firearm cartridge casing comprises determining an orientation of a reference image.

In some examples, the target orientation of the firearm cartridge casing comprises a horizontal orientation.

In some examples, rotating the image of the firearm cartridge casing to align the orientation of the firearm cartridge casing in the image with the target orientation comprises rotating the image of the firearm cartridge casing to align one or more markings on the head of the firearm cartridge casing with one or more markings on the head of a reference firearm cartridge casing in a reference image.

In some examples, the method includes determining a similarity between the rotated image and a reference image.

In some examples, the method includes identifying, based on the similarity between the rotated image and the reference image, a specific firearm that fired the firearm cartridge.

Other examples of this aspect include corresponding systems, apparatus, and computer programs, configured to perform the actions of the methods, encoded on computer storage devices.

Particular examples of the subject matter described in this specification can be implemented so as to realize one or more of the following advantages. When a toolmark examiner compares expended bullet cartridge casings under an optical comparison microscope or through any automated or semi-automated electronic forensic comparison system, they must ensure that the cartridge casings are physically aligned (i.e., rotated) such that the toolmarks under investigation can be accurately compared to a reference cartridge casing in a reference image. One innovative aspect of the disclosed mobile scanner is that it allows users not to be concerned about the (e.g., rotational) orientation of the physical cartridge casings with respect to camera coordinates of the camera during scanning. The user can simply insert the cartridge casings into the scanner, perform the scan, and the software application will auto-align the shell images to reference axes. This capability removes a highly technical, labor-intensive, and error-prone step from the flow, saving investigators in the field from expending time and effort to align cartridge casings manually by hand.

By providing a means to capture imaging data on-site and perform real-time analysis at a crime scene, criminal investigators can reduce the need to wait extended periods of time for delivery of the actual evidence to a forensic laboratory for analysis. A database repository of imaging data of stored microscopic features on fired casings for manufactured guns can be built, where imaging data collected by the forensic imaging apparatus can be compared to the stored imaging data to generate a search report that can identify criminal leads which criminal investigators may use in shooting investigations.

Once the investigators know that a particular firearm fired bullets at certain locations, they can start tying multiple crimes to specific people. Significant cost savings are possible to society when gun crimes are solved more quickly. Having a system in place, where leads can be generated while there is active case momentum, can promote faster resolution and greatly lowered cost to society in terms of dollars and tears.

Moreover, utilizing an adaptive kit that can leverage a user's smart phone or tablet device can result in a relatively accessible, significantly lower-cost solution than the current system reliance on lab-based microscopy, thus allowing a much larger number of agencies and departments to utilize the system. Increased accessibility can significantly increase a number of cartridge casings that can be compared, resulting in an increase of resolved firearms crimes.

The details of one or more examples of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example operating environment of a forensic imaging apparatus.

FIGS. 2A, 2B, and 2C depict schematic views of an example forensic imaging apparatus.

FIG. 3 depicts a schematic view of an example forensic imaging apparatus.

FIG. 4A is a cross-sectional cutaway view of a handgun identifying the breech block and firing pin.

FIG. 4B shows an example of a firearm cartridge identifying different parts thereof.

FIGS. 5A to 5C show example images of firearm cartridge casing heads with different firing pin aperture impression shapes.

FIGS. 6A to 6H show various orientations of a firearm cartridge casing head.

FIGS. 7A and 7B each depict two images of firearm cartridge casings aligned for comparison.

FIGS. 7C to 7F show example firearm cartridge casing heads exhibiting various breechface patterns.

FIG. 8 is a flow diagram of an example process for aligning an image of a firearm cartridge casing head.

FIG. 9 is a flow diagram of an example process of a forensic imaging system.

### DETAILED DESCRIPTION

Implementations of the present disclosure are generally directed to a system that employs computer vision techniques, including artificial intelligence, to automatically align and analyze cartridge casings that have been scanned by a field-deploy able scanning unit. The disclosed techniques can be used to align cartridge casings scanned at any (e.g., rotational) orientation with respect to a set of reference coordinates (e.g., camera coordinates of the camera of the field-deployable scanning unit) to a target orientation. The disclosed systems include computer implemented methods for perform the automatic alignment of images of cartridge casings, in order to enable the comparison of multiple different images of cartridge casings.

The disclosed systems can be used with an adaptive kit for in-field, real-time documentation, forensic analysis, and reporting of spent bullet casings using a mobile device with a camera, such as a smart phone. The systems and methods can be implemented with a software application installed on the mobile device and/or a networked server application to analyze the spent bullet casings and generate forensic reports. The forensic reports can include, for example, “chain of custody” verification regarding evidence recovery, e.g., suitable for admission as evidence in legal proceedings.

In use, the adaptive kit is affixed to a smart phone, tablet, or other user device including an internal camera. The adaptive kit includes an illumination (or lighting) module that can include a set of light sources, e.g., LEDs, a set of diffusers, or the like, arranged with respect to a sample holder within the adaptive kit to generate a illumination conditions suitable for imaging a sample casing using the internal camera or can include aperture(s) which allow light to be coupled into the housing from a user device illumination source (e.g., flash) to illuminate the sample casing at different angles by manipulating the casing in place in the holder assembly. The adaptive kit further can include a sample holder with a mounting mechanism to retain a sample casing, including a wide range of firearm ammunition caliber casings, while minimizing contact/contamination of the casing and which positions the sample casing at an imaging position. The adaptive kit can also include a macro lens for generating high resolution imaging conditions using the internal camera.

For example, images having a resolution over an object field sufficiently large to encompass the surface of the sample casing being imaged, e.g., of 8-megapixel resolution or more, of 12-megapixel resolution or more, etc. In some cases, this field size is 1 cm² or larger (e.g., 2 cm² or larger, 3 cm² or larger, such as 5 cm² or less). In some examples, the resolution is sufficiently high to resolve details on the sample casing having a dimension of 20 microns or less (e.g., 15 microns or less, 10 microns or less, 5 microns or less, e.g., 3-5 microns).

The lighting module is useful for illuminating a forensic sample under conditions suitable for photometric analysis. In some examples, the lighting module can direct light from each of multiple light sources to an illumination plane at a different angle of incidence. Imaging data is collected of a forensic sample that is retained by the sample holder and positioned in the illumination plane, where imaging data includes images capturing reflections and/or shadows cast by features on the forensic sample illuminated sequentially by a variety of different illumination conditions. For example, an image of the forensic sample can be captured when illuminated by each light source individually and/or by different combinations of the multiple light sources.

In some examples, light from a light source on a user device, e.g., camera flash, can be directed into an imaging barrel using a light pipe, for example, to one or more apertures located radially relative to the sample casing, and where the sample can be rotated 360 degrees to approximately synthesize photometric imaging conditions.

In some examples, non-neural network based computer vision techniques including image processing algorithms and/or a pre-trained machine-learned model(s) that have been trained on imaging data including a wide range of calibers of firearm ammunition and firearms can be utilized to generate a composite image from captured imaging data that includes multiple individual images, recognize features on the sample casing in the generated image, and develop understanding about the sample casing, e.g., make/model of the gun, identifying markings, firing conditions, etc. The composite image, e.g., generated from multiple images captured under different illumination conditions, can be utilized to recognize/track and compare features of the forensic sample and/or generate a three-dimensional rendering which may then be used to recognize/track and compare features of the forensic sample. Features of the forensic sample can include the drag mark 525 or firing pin aperture shear 526, which can be identified through classical algorithmic pattern-recognition and/or artificial intelligence. For example, neural networks like resnet 50 can identify features of the forensic sample from the image data of the forensic sample. Features can be compared using classic pixel value matching (which can be used to generate a Pearson Cross Correlation score, for example), or by providing the identified features to artificial neural network architectures like a Siamese network to compare the features.

The mobile device can collect forensic metadata, e.g., geolocation, time/date, or the like, and associate the metadata with the captured images and analysis. A database of forensic analysis reported results can be generated for use in on-going investigations and as a reference in future analysis/investigations. The forensic metadata can be utilized to provide a chain of custody record and can prevent contamination/tampering of evidence during an investigation. Metadata such as geolocation of evidence can be combined with other map-based information in order to extrapolate critical investigative data, e.g., tie a particular crime scene to one or more other related events.

The techniques described herein can be utilized to generate a “2D binary mask” of the shell surface topology from normal maps created by compositing images of the headstamp captured from a single overhead camera illuminated from multiple glancing angles around the shell. A detailed surface edge-map with surfaces with high reflectivity can be constructed, including metal and even completely mirrored finishes. Depth calibration data is captured from either area lights or structured light means and integrated into the overall reconstructed surface map.

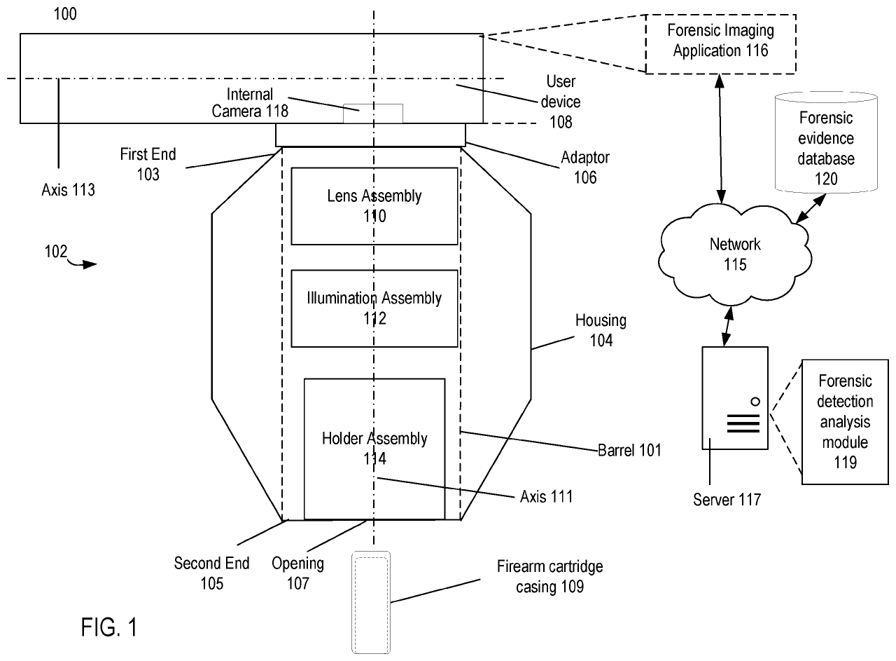

FIG. 1 depicts an example operating environment 100 of a forensic imaging apparatus 102. Forensic imaging apparatus 102 includes a housing 104 and an adaptor 106 affixing the forensic imaging apparatus 102 to user device 108, such as a mobile phone, and enables high resolution imaging of a firearm cartridge casing 109 by an internal camera 118 of user device 108.

Adaptor 106 is attached to housing 104 at a first end 103 and configured to affix forensic imaging apparatus 102 to user device 108. At the opposite end 105, housing 104 includes an opening 107 configured to receive firearm cartridge casing 109, where opening 107 is sufficiently large to receive the firearm cartridge casing 109. For example, opening 107 can have a diameter larger than a diameter of various common firearm cartridges. In some examples, opening 107 has a diameter of 1 cm or more (e.g., 2 cm or more, such as up to 5 cm). Housing 104 can be formed in various shapes, for example, cylindrical, conical, spherical, planar, triangular, octagonal, or the like. Opening 107 can include an elastic/flexible material, e.g., rubber, configured to deform/stretch in order to accept a range of cartridge casing diameters.

Generally, housing 104 can be formed from one or more of a variety of suitable structural materials including, for example, plastic, metal, rubber, and the like. For example, housing 104 can be formed from materials that can be readily molded, machined, coated, and/or amenable to other standard manufacturing processes.

Housing 104 defines a barrel 101 extending along an axis 111 and forensic imaging apparatus 102 includes a lens assembly 110, an illumination assembly 112, and a holder assembly 114 arranged in sequence along axis 111. In some examples, one or more of the lens assembly 110, illumination assembly 112, and holder assembly 114 affixed within barrel 101, e.g., retained within the housing 104.

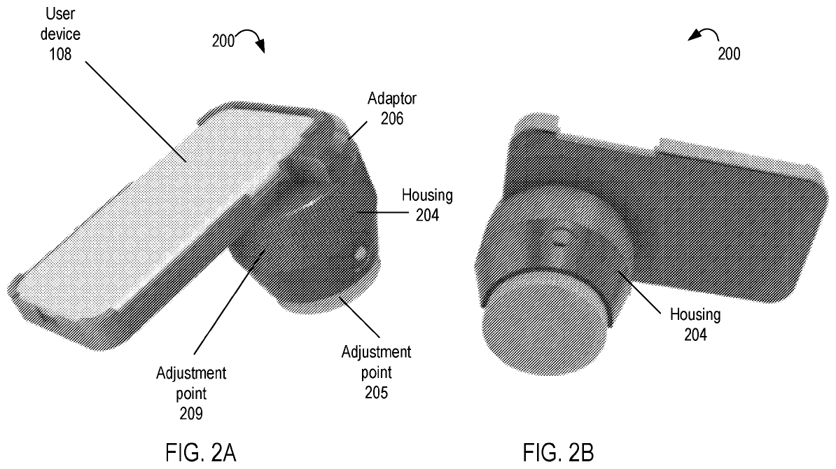

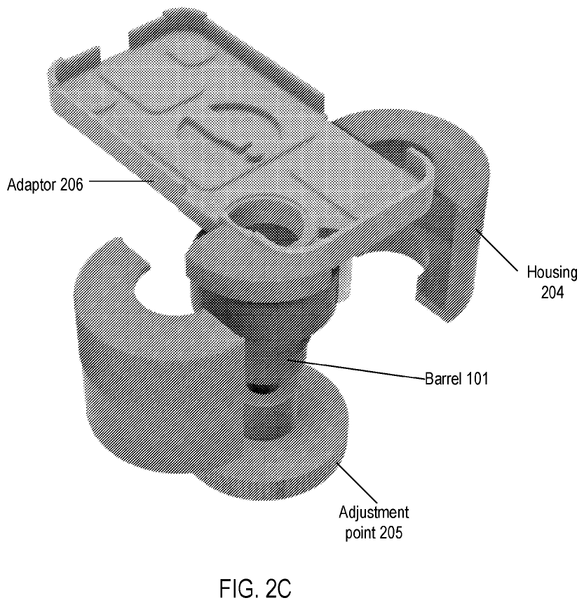

Adaptor 106 can include, for example, a clamp, a cradle, or the like, to attach the apparatus 102 at end 103 to user device 108. Adaptor 106 can include, for example, a case-style fixture for a user device to retain at least a portion of the user device 108 as well as to hold the housing 104 at a particular orientation with respect to the user device 108, e.g., aligned with respect to an internal camera of the user device 108. Adaptor 106 can orient lens assembly 110 of the forensic imaging apparatus 102 at a particular orientation with respect to the internal camera of the user device 108, e.g., to coaxially align an optical axis of the internal camera with an optical axis of lens assembly 110 and/or to position an illumination plane in the apparatus 102 at a focal plane of the optical imaging system composed of the internal camera of the user device and lens assembly 110. In some examples, as depicted in FIG. 1, adaptor 106 is configured to orient housing 104 along axis 111 and perpendicular to a plane (defined by an axis 113 and an axis extending out of the plane of the figure) of the user device 108. In some examples, the adaptor 106 orients housing 104 and axis 111 parallel to an axis 113 of the user device 108. Further discussion of the adaptor 106 can be found below with reference to FIGS. 2 and 3.

In general, lens assembly 110 is a macro lens formed by one or more lens elements, e.g., the macro lens can be a compound macro lens composed of two or more lens elements, or the macro lens can be formed from a single lens element. In some examples, the lens assembly can include multiple selectable lenses, e.g., on a rotating carousel, where a particular lens of the multiple selectable lenses (e.g., each having a different magnification) can be selectively rotated into the optical path along axis 111. In some examples, lens assembly or another portion of the housing 104 may be adjustable to adjust a distance between lens assembly and the internal camera 118, e.g., to adjust based on a focal length of a selected lens of the multiple selectable lenses.

In some examples, the one or more lenses of the lens assembly 110 can be selected to provide magnification of features (e.g., one or more markings) of the firearm cartridge casing 109, e.g., breech face markings, firing pin aperture markings, ejection markings, and the like. For example, lens assembly 110 can have a magnification of 1.5X or more (e.g., 2X or more, 3X or more, 4X or more, 5X or more, 10X or more). Further discussion of the lens assembly 110 is found below with reference to FIG. 3.

Illumination assembly 112 can be affixed within the housing 104 and oriented to provide illumination within the barrel 101 defined by housing 104. Illumination assembly 112 can include multiple light sources arranged between the first end 103 and an illumination plane, where the multiple light sources may be operated alone or in combination to illuminate at least a portion of interior of the housing 104, e.g., an area including an illumination plane for imaging a firearm cartridge casing 109, and which may be operated in a manual, automatic, or semi-automatic manner. Illumination assembly 112 generally provides lighting sufficient for generating photometric conditions appropriate for capturing light reflected by surfaces of a portion of the firearm cartridge casing 109, e.g., a head region with internal camera 118. Internal camera 118 can include a lens assembly and sensor, e.g., CMOS sensor, CCD, or the like. In some examples, internal camera 118 includes a resolution of at least 12 megapixels, e.g., 16 megapixels. The amounts of light captured, e.g., shadows and reflections, by an internal camera 118 for a particular light source of multiple light source can be utilized to generate a three-dimensional model of the portion of the firearm cartridge casing. The three-dimensional model can be used to recognize and extract features of a firearm cartridge casing 109 positioned within the housing 104 and retained by the holder assembly 114 and be compared against similarly captured imaging data stored in forensic evidence storage database 120.

In some examples, operation of the illumination assembly 112 can be controlled through application 116 on the user device 108. Operations of the illumination assembly can include, for example, particular light sources of the multiple light sources that are in ON versus OFF states, intensities of the light sources, and the like.

Illumination assembly 112 can include light sources of different types, e.g., light emitting diodes (LEDs), diffuser area lights, light propagated from the flash of device 108 through a light pipe, laser-based coherent light sources coupled to a diffraction grating, etc. Each of the light sources of the illumination assembly can be oriented such that at least a portion of light output of each of the light sources is incident on an illumination plane within the housing 104.

Holder assembly 114 can include a holder that is affixed within the barrel 101 defined by housing 104 and configured to retain the firearm cartridge casing 109 within the housing 104 and relative to the illumination assembly 112 and lens assembly 110 such that the firearm cartridge casing 109 is held at an illumination plane during an imaging process. Holder assembly 114 can include a casing stabilizer including fixtures for holding the firearm cartridge casing 109.

In some examples, holder assembly 114 can include a holder that includes a mechanical iris for securing and positioning the firearm cartridge casing 109 in an orientation relative to the forensic imaging apparatus, e.g., with respect to a focal plane of an internal camera of the forensic imaging apparatus. The mechanical iris can include multiple moving blades, where each moving blade overlaps another, different moving blade of the multiple moving blades, and where the mechanical iris includes an opening through which a firearm cartridge casing 109 can at least partially pass through. Holder assembly 114 can include an external adjustment point located at least partially on an exterior of the housing 104, where a user can use the external adjustment point to loosen or tighten the holder assembly, e.g., open or close the mechanical iris, by adjusting the external adjustment point. In one example, the external adjustment point can be a knob or rotating fixture that a user can turn in a particular direction to adjust the holder assembly 114, e.g., open/close the mechanical iris.

In some examples, the holder assembly can include internal registration detents which mate with bumps on the external adjustment point instead of a mechanical iris to affix the cartridge casing in place. In some examples, the cartridge casing can be placed into a simple cylindrical chuck and pressed into the opening 107 to position the shell in place.

In general, user device 108 may include devices that host and display applications including an application environment. For example, a user device 108 is a user device that hosts one or more native applications that includes an application interface (e.g., a graphical-user interface (GUI)). The user device 108 may be a cellular phone or a non-cellular locally networked device with a display. The user device 108 may include a cell phone, a smart phone, a tablet PC, a personal digital assistant (“PDA”), or any other portable device configured to communicate over a network 115 and display information. For example, implementations may also include Android-type devices (e.g., as provided by Google), electronic organizers, iOS-type devices (e.g., iPhone devices and others provided by Apple), other communication devices, and handheld or portable electronic devices for gaming, communications, and/or data organization. The user device 108 may perform functions unrelated to a forensic imaging application 116, such as placing personal telephone calls, playing music, playing video, displaying pictures, browsing the Internet, maintaining an electronic calendar, etc.

User device 108 can include a processor coupled to a memory to execute forensic imaging application 116 to perform forensic imaging data collection and analysis. For example, the processor can be utilized interface/control the operations of forensic imaging apparatus 102 and an internal camera 118 of the user device 108 to capture imaging and video data of surface(s) of a firearm cartridge casing 109. Further, processor can analyze the image/video data to detect a variety of features of the firearm cartridge casing 109. Features can include one or more markings (e.g., striations) including, for example, breech face marking, firing pin aperture markings, ejection marking, and the like. The processor may generate forensic sample data including images, video, GPS data, and the like.

In some examples, the processor may be operable to generate ballistic imaging metadata from the ballistic specimen data, e.g., locally stored data on user device 108 or stored on a cloud-based server 117. For example, the processor may generate a three-dimensional mathematical model of the specimen from the captured image data, detecting one or more dimensions of the tool marks to form an associated set of metadata.

In some examples, the processor may be operable to generate and send a hit report of the forensic evidence to a receiving networked device, e.g., a central processing location. In some examples, the processor may be operable to perform preliminary analysis on the captured imaging data, where striations (e.g., one or more markings) are detected within the captured imaging data using past ballistic imaging data downloaded from a database, e.g., via a network, and the sample striation image patterns stored within the database. The processor may be operable to mark the detected striations on the captured image data prior to sending the marked image data within the ballistic specimen data to the receiving networked device. Further the processor may be able to identify criminal patterns based upon the hit report at the user device 108 and filter suspect data based upon these identified criminal patterns, along with a set of forensic policies.

User device 108 can include a forensic imaging application 116, through which a user can interact with the forensic imaging apparatus 102. Forensic imaging application 116 refers to a software/firmware program running on the corresponding user device that enables the user interface and features described throughout and is a system through which the forensic imaging apparatus 102 may communicate with the user and with location tracking services available on user device 108. The user device 108 may load or install the forensic imaging application 116 based on data received over a network 115 or data received from local media. The forensic imaging application 116 runs on user devices platforms, such as iPhone, Google Android, Windows Mobile, etc. The user device 108 may send/receive data related to the forensic imaging apparatus 102 through a network. In one example, the forensic imaging application 116 enables the user device 108 to capture imaging data for the firearm cartridge cases 109 using the forensic imaging apparatus 102.

In some examples, forensic imaging application 116 can guide an operator of user device 108 and forensic imaging apparatus 102 through a process of one or more of collecting, imaging, and analyzing a forensic sample, e.g., a firearm cartridge casing 109. Forensic imaging application 116 can include a graphical user interface including a visualization of the firearm cartridge casing 109 as captured by internal camera 118 while the firearm cartridge casing 109 is inserted into the forensic imaging apparatus 102, e.g., to assist in insertion/retention of the casing into holder assembly 114. Forensic imaging application 116 can guide an operator through the process of capturing a set of images under various imaging conditions.

The forensic imaging application 116 can have access to location tracking services (e.g., a GPS) available on the user device 108 such that the forensic imaging application 116 can enable and disable the location tracking services on the user device 108. GPS coordinates of a location associated with the forensic sample, e.g., a location where the firearm cartridge casing 109 is found, can be captured. Forensic imaging application 116 can include, for example, camera capture software, which enables a user to capture imaging data of the firearm cartridge casing 109 in an automatic, semi-automatic, and/or manual manner.

In some examples, user device 108 can send/receive data via a network 115. The network 115 can be configured to enable exchange of electronic communication between devices connected to the network. The network 115 can include, for example, one or more of the Internet, Wide Area Networks (WANs), Local Area Networks (LANs), analog or digital wired and wireless telephone networks (e.g., a public switched telephone network 115 (PSTN), Integrated Services Digital Network 115 (ISDN), a cellular network, and Digital Subscriber Line (DSL), radio, television, cable, satellite, or any other delivery or tunneling mechanism for carrying data. A network 115 may include multiple networks or subnetworks, each of which may include, for example, a wired or wireless data pathway. A network 115 may include a circuit-switched network, a packet-switched data network, or any other network 115 able to carry electronic communications (e.g., data or voice communications). For example, a network 115 may include networks based on the Internet protocol (IP), asynchronous transfer mode (ATM), the PSTN, packet-switched networks based on IP, X.25, or Frame Relay, or other comparable technologies and may support voice using, for example, VoIP, or other comparable protocols used for voice communications. A network 115 may include one or more networks that include wireless data channels and wireless voice channels. A network 115 may be a wireless network, a broadband network, or a combination of networks includes a wireless network 115 and a broadband network.

In some examples, user device 108 can be in data communication with a cloud-based server 117 over the network. Cloud-based server 117 can include one or more processors, memory coupled to the processor(s), and database(s), e.g., a forensic evidence database 120, on which raw and/or processed imaging data and metadata associated with firearm cartridge casings 109 can be stored. The server 117 can include a forensic detection analysis module 119 for receiving data, e.g., imaging data, metadata, and the like, from the user device 108, performing analysis on the received data, and generating reports based on the analyzed data.

In some examples, the forensic imaging application 116 can generate and send data via the network 115 to the cloud-based server 117 including imaging data, video data, GPS data, and the like. In response, the forensic detection analysis module 119 on server 117 can generate ballistic imaging metadata from the provided data. In one example, the forensic detection analysis module 119 can generate a three-dimensional mathematical model of the firearm cartridge casing 109 from the captured imaging data, detect one or more features, e.g., dimensions of the tool marks, and generate a set of metadata for the firearm cartridge casing 109. The server 117 can generate a hit report of the firearm cartridge casing 109 and provide the hit report to the user device 108 via the network.

In some examples, the forensic detection analysis module 119 may detect one or more dimension measurements of one or more tool marks and identify an associated position of each tool mark on the firearm cartridge casing 109. The dimension measurements may include the number of tool marks, the width and depth of each tool mark, the angle and direction of each spiral impression within the specimen, and the like. The forensic detection analysis module 119 may compare the dimension measurement and the position to a second set of stored forensic evidence measurements, e.g., stored on database 120. Further, forensic detection analysis module 119 may detect a best match within a predetermined range of the dimension measurement and position. As a result, the forensic detection analysis module 119 can identify a forensic evidence specimen and a suspect associated with the detected best match and generate a list of each identified casing 109 and an associated suspect to form the hit report having suspect data. Similarity can be determined, for example, by using classic pixel value comparison (which can be used to generate a Pearson Cross Correlation score, for example) or by using artificial neural network architectures like a Siamese network. Similarity scores can be mapped to match probability through a transfer function that is calibrated using a histogram analysis of known matches to be known non-matches.

Some or all of the operations described herein with reference to the forensic detection analysis module 119 can be performed on the user device 108. For example, a preliminary analysis can be performed by the forensic imaging application 116 on the captured imaging data at the user device 108, where striation markings are detected within the captured image data using the past ballistic imaging data downloaded from the networked server 117 and sample striation image patterns stored within a database 120. The processor of user device 108 can convert the two-dimensional images captured by camera 118 into a three-dimensional model of the forensic evidence to be stored in database 120.

Database 120 can include multiple databases each storing particular set of data, e.g., including one for network server data, sample tool marking patterns, user data, forensic policies, and ballistic specimen (e.g., firearm cartridge casing) data. Historical forensic data, e.g., forensic reports generated for multiple casings 109, manufacturer data, e.g., “golden” samples for casing/firearm pairs, and human-expert generated reports, e.g., using three-dimensional scanners, can be stored on database 120 and accessed by forensic imaging application 116 and/or forensic detection analysis module 119.

FIG. 2A. 2B, and 2C depict schematic views of an example forensic imaging apparatus 200 with user device 108 attached. Forensic imaging apparatus 200 includes an adaptor 206 that orients and affixes the forensic imaging apparatus 200 to user device 108. As depicted in FIG. 2A, adaptor 206 includes a case-type adaptor, where user device 108, in this case, a smart phone, fits into the smart phone case such that the housing 204 and components therein are oriented and affixed relative to the user device 108. Housing 204 can include an adjustment point 205 including exterior texture, e.g., surface marks, to assist a user in holding and adjusting a position of housing 204. For example, grip marks can be used to assist a user in holding and turning a portion of the housing 204. In certain examples, the housing features a lens adjustment ring 209 having an exterior texture to allow a user to make adjustments to the lens assembly in the housing, e.g., to select a particular lens of multiple selectable lenses and/or to adjust focus of the lens assembly.

FIG. 3 depicts a schematic cross-sectional schematic view of an example of a forensic imaging apparatus 102 perpendicular to the illumination plane. In the embodiment depicted in FIG. 3, a holder 301 is configured to retain and stabilize the firearm cartridge casing 109 within the housing 104 so that a portion of the firearm cartridge casing 109, e.g., a head region of the casing, is located at an illumination plane 306. The head of the casing can include a case head of the casing e.g., one or more of a base of the casing, a rim of the casing, extractor groove, and a portion of the body of the firearm cartridge casing 109. For example, the head of the casing can include a base of the casing and heel of the casing. Holder assembly 114 can additionally be configured to accommodate a range of diameters for various firearm cartridge casings and prevent external light from entering within housing 104 when the casing 109 is secured within the holder assembly.

Lens assembly 110 includes a lens element 311, for example, forming a macro lens, where the lens assembly 110 can define a focal plane at the illumination plane 306. In some examples, lens assembly 110 can include multiple selectable lenses 311, e.g., each having a different magnification. The multiple selectable lenses 311 can be retained in an automated, semi-automated, or manual housing, e.g., a lens/filter wheel that allows for a particular lens 311 to be aligned along axis 111. Lens assembly 110 can additionally include one or more adjustment points for altering a position of the lens 311 along the axis 111, e.g., to align the lens 311 such that the focal point of the lens is aligned with the illumination plane 306.

In some examples, a conical ring can be utilized to retain lens 311 within the lens assembly 110. Lens 311 can include a custom molded lens to optimize geometry for the apparatus 102 or can incorporate off-the-shelf optics.

In some examples, the illumination assembly includes multiple light sources. For example, LED illumination is used, and illumination assembly 112 can include one or more rows of 4 to 32 (or more) illumination sources (e.g., 16) positioned radially around the casing 109. In another example, structured light sources, e.g., laser diodes, can be used, and illumination assembly 112 can include one or more structured light assemblies positioned radially around the casing 109.

In some examples, light from the flash from device 108 is utilized as a light source, and an aperture is used to direct light from the flash to the illumination plane. The casing 109 can be rotated 360 degrees either manually through a series of registration positions or through the use of a small motor to enable the photometric process to run.

Specifically, the illumination assembly embodiment shown in FIG. 3 includes multiple point light sources arranged in two different tiers with respect to illumination plane 306, including light sources 307 arranged in a first tier 310 and light sources 308 arranged in a second tier 312. At least one tier of illumination can be utilized. Additional tiers of illumination at higher angles of incidence can be utilized to provide more illumination detail, while maintaining reflections off the metallic surface below a threshold. Note that the angle of incidence is measured from the normal to the illumination plane, which corresponds to axis 111. A point light source is considered to be a light source that is sufficiently small that, for purposes of analyzing images acquired using the light source, all the light rays useful for tracing the path of the light to the camera can be considered to originate from a single point. In some examples, polarizers and/or filters can be implemented in combination with one or more of the tiers, for example, to reduce reflections generated by the light sources.

Light sources 307 and 308 can be affixed to housing 104 by respective light source fixtures 314. The light sources can be recessed within the light source fixtures 314 which reduce stray light and/or reflection from a surface of the light sources from reaching the illumination plane. For example, each light source can be positioned within light source fixture 314 at an offset register that results in a louver effect.

In addition to point light sources 307 and 308, the illumination assembly can include one or more spatially-extended light sources 316. A spatially-extended light source is a light source that is too large to be considered a point light source. Spatially-extended light sources can be considered, for purposes of ray tracing, as a combination of multiple point light sources. The spatially-extended light sources are positioned with respect to the illumination plane 306 to provide uniform surface illumination on the head of the firearm cartridge casing 109 within a field of view of the lens assembly 110 when the firearm cartridge casing 109 is held at the illumination plane 306 by the holder assembly 114. For example, one or more light sources 316, e.g., three light sources 316, can include a light emitting element (e.g., a LED) with a diffusing light guide arranged to emit light across an extended area and positioned perpendicular to axis 111 and between the illumination plane 306 and the lens assembly 110.

In some examples, electronics 318, e.g., data processing apparatus, electrical controller (e.g., microcontrollers), data communication link, power indicators (showing ON/OFF status), or the like, and/or power supply 320 for the forensic imaging apparatus 102 can be located within housing 104 and affixed to housing 104. Power supply 320 can include a battery (e.g., a rechargeable battery), power management, power switch, AC/DC converter, and the like, and can be operable to provide power to the electronics 318 and illumination assembly 112, e.g., light sources 308, light source 316. Power supply 320 can be operable to provide power to particular light sources 308, light source 316, e.g., one light source at a time. In some examples, power supply 320 can be operable to provide power to lens assembly 110, e.g., an automated/semi-automated lens selection wheel, and/or to the holder assembly 114, e.g., an automated/semi-automated holder.

Electronics 318 can include an electronic processing module, e.g., an electrical controller, that is programmed to control the operation of the illumination assembly 112, e.g., turning ON/OFF light sources 308, 316.

Electronics 318 can include one or more data communication links. A data communication link can be wired, e.g., micro-USB, or wireless, e.g., Bluetooth, Wi-Fi, or the like. Data communication link can be utilized by the forensic imaging apparatus 102 to send/receive data via the data communication link to user device 108 and/or to a cloud-based server 117 via a network. In one example, electronics 318 can include a micro-USB cable to allow transfer of data between the forensic imaging apparatus 102 and user device 108. Data communication link can be used to connect the forensic imaging apparatus 102 and an electronic processing module that is programmed to control the illumination assembly 112 and internal camera 118 included in user device 108, such that the electronic processing module included in the user device 108 can control the operation of the illumination assembly 112, e.g., turning ON/OFF light sources 307, 308, 316 and acquire images with the camera.

In some examples, the electronic processing module is programmed to sequentially illuminate the head of the firearm cartridge casing 109 with light from light sources of the illumination assembly 112 at a varying range of angles of incidence and azimuth at the illumination plane 306, and acquire, with the internal camera 118, at least one image of the head of the firearm cartridge casing 109 while the head of the firearm cartridge casing 109 is illuminated by a corresponding light source of the multiple light sources.

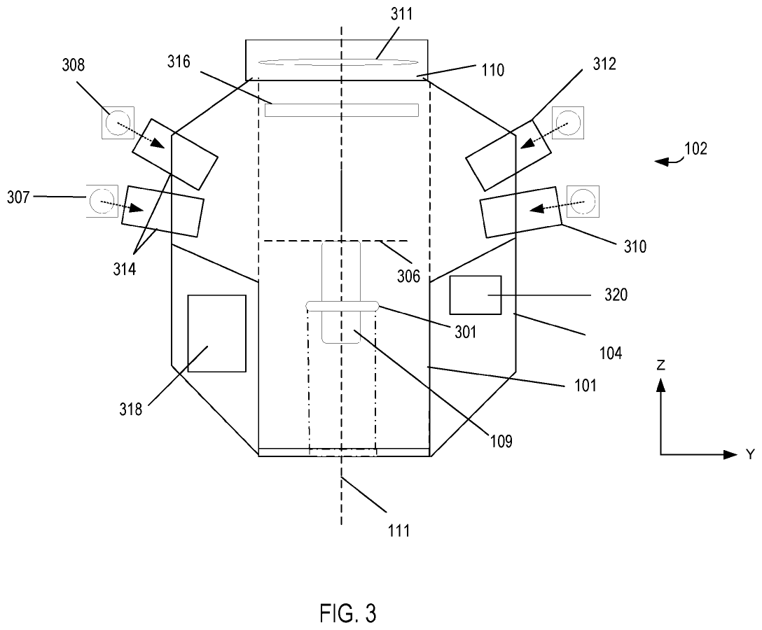

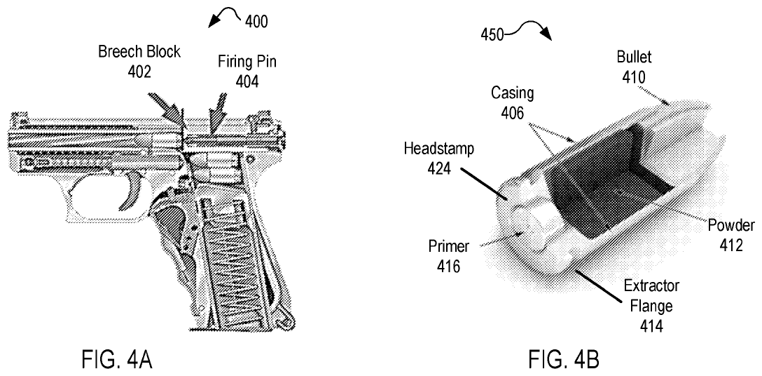

FIG. 4A is a cross-sectional cutaway view of a handgun 400. The handgun 400 is a “recoil-action” gun. The handgun 400 includes a breech block 402 and a firing pin 404. The breech block is the part of the firearm that closes the breech of a breech loading weapon before or at the moment of firing. The breech block seals the breech and contains the pressure generated by the ignited propellant. Retracting the breechblock allows the chamber to be loaded with a cartridge. During a firing event, the firing pin 404 emerges through a firing pin aperture, or hole, to strike a firearm cartridge.

FIG. 4B shows an example of a firearm cartridge 450. The firearm cartridge 450 includes a headstamp 424, primer 416, extractor flange 414, powder 412, bullet 410, and cartridge casing 406. The cartridge casing 406 can be a metal cylinder that serves as a container for the other components of the firearm cartridge 450.

The primer 416 is the ignition component of the firearm cartridge 450. The primer 416 may be in the form of a metal disk centered in one end of the cartridge casing 406. The primer 416 can be formed from a soft metal, such as copper or brass alloy. Upon being struck with sufficient force generated by the firing pin 404, the primer 416 reacts chemically to produce heat, which gets transferred to the main propellant charge, e.g., the powder 412. The powder 412 ignites, burning rapidly and providing expanding gases that propel the bullet 410 down the barrel of the handgun 400.

Firing pin aperture shear occurs when the soft primer metal flows back through the firing pin aperture in the breech block on the gun during the firing process. The primer metal then is sheared, or chopped, as the bullet 410 is ejected from the gun. Striae marks left behind on the headstamp 424 of the cartridge are residual artifacts of the imperfections present on the perimeter of the firing pin aperture on the breech block 402.

During a firing event, the primer of a cartridge case is struck with a firing pin that has a particular shape, and the firing pin also has individual characteristics that can be impressed in the metal on the primer. The pattern scratched or impressed on cartridge cases fired through one firearm will be different from the pattern of another firearm, even of the same make and model. If there is sufficient similarity between the microscopic marks produced by the firearm and the marks observed on the evidence, then an identification can be made.

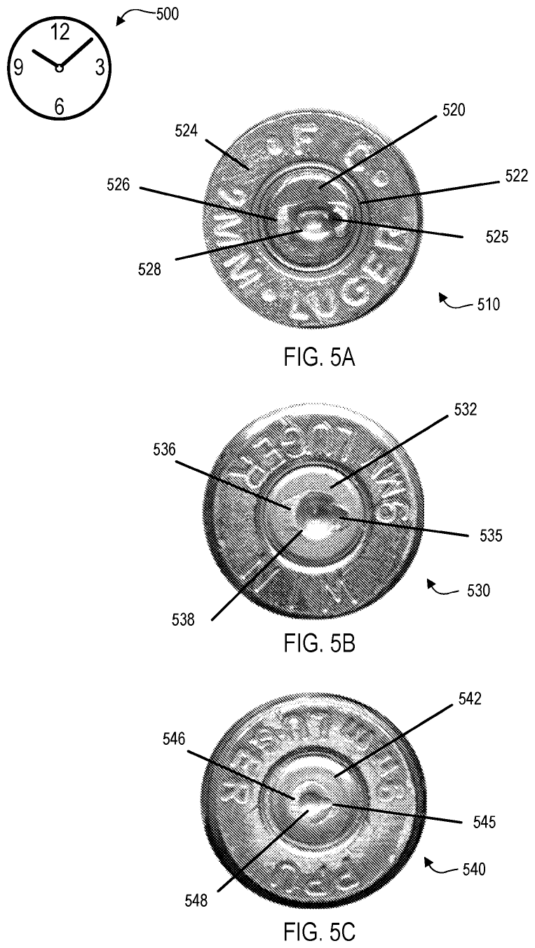

FIGS. 5A to 5C show example images of firearm cartridge casing heads with different firing pin aperture impression shapes. FIGS. 5A to 5C show various toolmarks, or impression marks, that are left behind on bullet cartridge headstamps and can be used to examine firearm cartridge casings. FIG. 5A shows an example cartridge casing head that was fired from a gun with a rectangular firing pin aperture. FIG. 5B shows an example cartridge casing head that was fired from a gun with a teardrop shaped firing pin aperture. FIG. 5C shows an example cartridge casing head that was fired from a gun with a circular firing pin aperture.

FIG. 5A shows an example image of a spent shell cartridge casing head 510 that was fired from a gun with a rectangular firing pin aperture. The cartridge casing head 510 includes a headstamp 524, a breechface 520, and a primer pocket 522. A firing pin aperture impression 528 is visible on the breechface 520, or primer area. The firing pin aperture impression 528 was left by a rectangular shaped firing pin aperture. Firing pin aperture shear 526 is also visible on the breechface 520. The firing pin aperture shear 526 appears as a region of striations, or scratch marks. A drag mark 525 is visible on the breechface 520. The drag mark 525 appears as an impression that extends radially outward from the firing pin aperture impression 528 and is narrower than the firing pin aperture impression 528.

Orientations of cartridge casing heads captured by camera, e.g., internal camera 118, can be described with respect to a set of reference axes. For example, XY axes, a clock face, or the like. FIG. 5A includes a clock face 500 for directional reference. Orientations of cartridge casing heads captured in images by the camera can be described with reference to the clock face. Generally, 3 o'clock and 9 o'clock define a horizontal orientation, while 12 o'clock and 6 o'clock define a vertical orientation. For example, the cartridge casing head 510 captured in an image by the camera can be described as having a horizontal orientation with the drag mark 525 at 3 o'clock, and the firing pin aperture shear 526 at 9 o'clock. Although described herein with reference to clock directions, the orientation of a firearm casing head can also be measured as an angular direction (e.g., with reference to a horizontal or to a vertical of the reference axes). At times, a set of reference axes (e.g., clock orientations of a clock face) can be defined based on the camera coordinates, i.e., an orientation of the camera. For example, a vertical alignment (e.g., positions of 12 o'clock and 6 o'clock) of the clock face can be aligned with a Y axis of the camera coordinates. In another example, a horizontal alignment (e.g., positions of 3 o'clock and 9 o'clock) can be aligned with an X axis of the camera coordinates.

For cartridge casing that were fired from guns with elongated firing pin aperture impressions (e.g., rectangular or teardrop-shaped), the orientation of the firing pin aperture impression can be used to determine the orientation of the cartridge casing. Generally, any mark can be used as a reference point for rotational alignment of the captured cartridge casing with respect to reference axes, including the drag mark 525 or the breechface patterns on the primer area.

In general, the forensic detection analysis module 119 receives images of cartridge casing heads at arbitrary orientations and aligns the images so that the cartridge casing heads align with a target orientation with respect to reference axes (e.g., as defined by a clock face). In some examples, the target orientation for a rectangular firing pin aperture is as shown in FIG. 5A, with the firing pin aperture impression aligned horizontally, the drag mark 525 to the right at 3 o'clock, and the shear 526 to the left at 9 o'clock. The target orientation may be the same for any elongated (e.g., rectangular, elliptical, teardrop) firing pin aperture shapes. The target orientation can be adjusted to any specified rotational orientation. In some examples, the target orientation can be determined based on breechface patterns instead of, or in addition to, the firing pin aperture impressions.

FIG. 5B shows an example image of a spent shell cartridge casing head 530 that was fired from a gun with a teardrop-shaped firing pin aperture impression. A firing pin aperture impression 538 is visible on the breechface 532. The firing pin aperture impression 538 was left by a teardrop shaped firing pin aperture. Firing pin aperture shear 536 is also visible on the breechface 532. The firing pin aperture shear 536 appears as a region of striations, or scratch marks. A drag mark 535 is visible on the breechface 532. The drag mark 535 appears as an impression that extends radially outward from the firing pin aperture impression 538 and is narrower than the firing pin aperture impression 528. The cartridge casing head 530 can be described as having an orientation with the drag mark 535 at 3 o'clock, and the firing pin aperture shear 536 at 9 o'clock. This horizontal orientation is similar to the orientation of the cartridge casing head 510 of FIG. 5A. In some implementations, the horizontal orientation is the target orientation for images of cartridge casing heads with teardrop shaped firing pin aperture impressions.

FIG. 5C shows an example image of a spent shell cartridge casing head 540 that was fired from a gun with a circular firing pin aperture. A firing pin aperture impression 548 is visible on the breechface 542. The firing pin aperture impression 548 was left by a circular shaped firing pin aperture. Firing pin aperture shear 546 is also visible on the breechface 542. The firing pin aperture shear 536 appears as a region of striations, or scratch marks. A drag mark 545 is visible on the breechface 542. The drag mark 545 appears as an impression that extends radially outward from the firing pin aperture impression 548 and is narrower than the firing pin aperture impression 548. The cartridge casing head 540 can be described as having an orientation with the drag mark 545 at 3 o'clock, and the firing pin aperture shear 546 at 9 o'clock. This horizontal orientation is similar to the orientation of the cartridge casing head 510 of FIG. 5A and of the cartridge casing head 530 of FIG. 5B. In some implementations, the horizontal orientation is the target orientation for images of cartridge casing heads with circular firing pin aperture impressions. In some examples, the target orientation can be determined based on breechface patterns instead of, or in addition to, the firing pin aperture impressions.

For all firing pin aperture impression shapes, if there is no drag mark visible, and it is not obvious which side the striations are predominantly populated on, the forensic detection analysis module 119 can orient the scratch marks horizontally. The horizontally oriented image can then be compared to a reference image. In this case there are two possible orientations that could be valid for comparison phases, e.g., 0 degrees or 180 degrees. Both orientations are used when performing any subsequent comparison analysis.

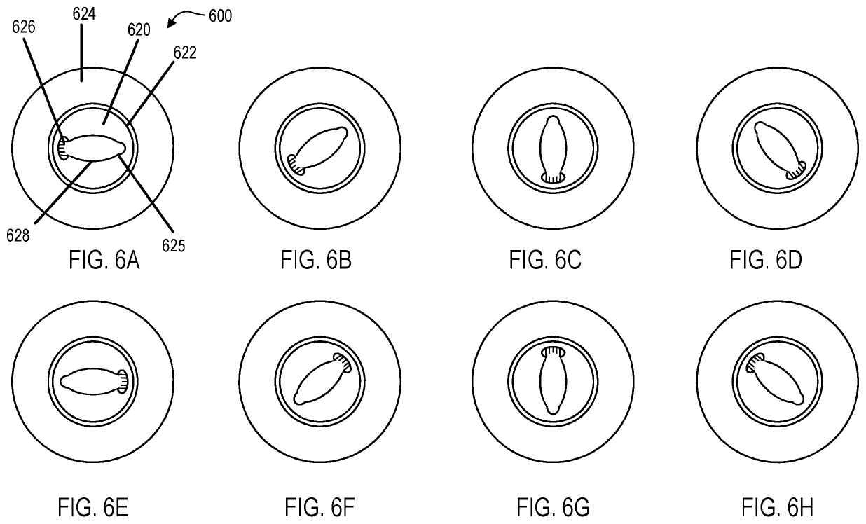

FIGS. 6A, 6B, 6C, 6D, 6E, 6F, 6G, and 6H shows various orientations of an example cartridge casing head 600. The cartridge casing head includes a headstamp 624, a breechface 620, and a primer pocket 622. A firing pin aperture impression 628 is visible on the breechface 620. The firing pin aperture impression 628 was left by a rectangular or elliptical shaped firing pin aperture. Firing pin aperture shear 626 is also visible on the breechface 620. A drag mark 625 is visible on the breechface 520.

FIG. 6A shows the cartridge casing head 600 at a target orientation, e.g., with reference to a reference clock face. At the target orientation, the drag mark 625 is at 3 o'clock, and the firing pin aperture shear 626 is at 9 o'clock. Scratch marks, or striations of the firing pin aperture shear 626 are therefore oriented horizontally.

FIGS. 6B to 6H show the cartridge casing head 600 at various other possible orientations. The orientations shown in FIGS. 6B to 6H are not useful for comparison against reference images of cartridge casing heads, unless the cartridge casing head in the reference image is also set to the same orientation.

Upon receiving an image of the cartridge casing head, the forensic detection analysis module 119 can determine an orientation of the cartridge casing head 600. For example, the forensic detection analysis module 119 may receive an image of the cartridge casing head 600 oriented with the drag mark 625 at 6 o'clock, as shown in FIG. 6G. The forensic detection analysis module 119 can determine that the drag mark 625 is at 6 o'clock, and that the target orientation has the drag mark 625 at 3 o'clock. Thus, the forensic detection analysis module 119 can determine to rotate the image of the cartridge casing head 600 ninety degrees counter clock-wise, to orient the drag mark 625 at the target orientation of 3 o'clock.

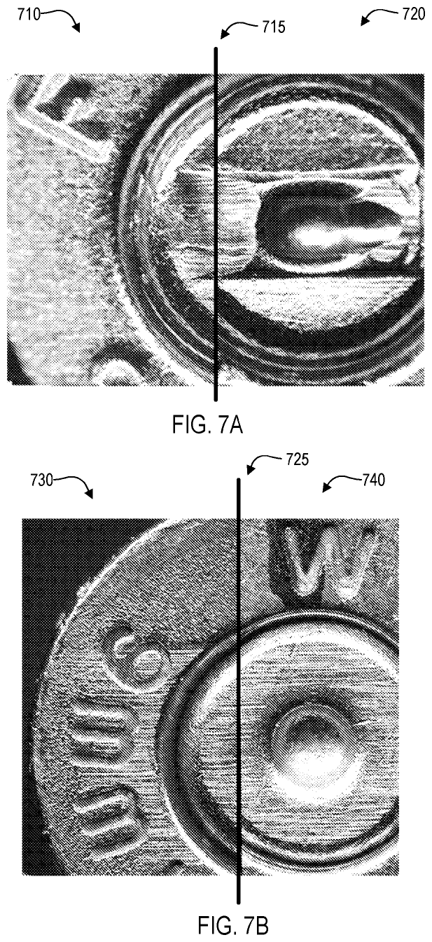

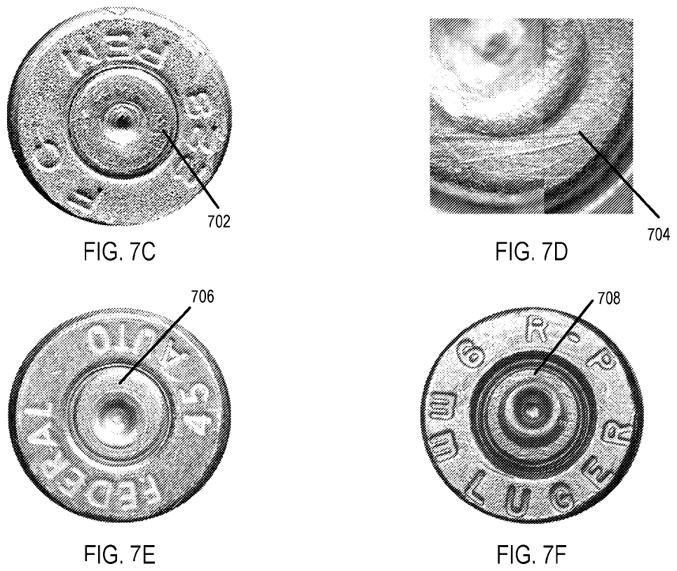

FIGS. 7A and 7B each depict two images of firearm cartridge casings aligned for comparison. FIG. 7A shows two images 710, 720 of cartridge casing heads, or cartridge casings, aligned for comparison. The image 710 may be a reference image, e.g., from the forensic evidence database 120. The image 720 may be an image of a shell collected in the field. Regardless of the orientation at which the image 720 was initially captured (e.g., by the camera of the forensic imaging apparatus), the forensic detection analysis module 119 automatically rotates the image 720 to align the captured orientation of the cartridge casing head with the target orientation, e.g., the orientation of the cartridge casing head of the reference image 710. Thus, the scratch patterns on the headstamps are aligned to show the similarity in striation patterns across the two cartridge casings on either side of a vertical dividing line 715.

Aligning cartridge casings in this manner makes it possible for an examiner to assess whether the patterns on the two cartridge casings resemble one another and whether the cartridge casings are associated with the same firearm. As part of their investigation, toolmark examiners may try to determine if the markings on the cartridge casing headstamp surface exhibit similar characteristics to the reference cartridge casing. For instance, the toolmark examiner can analyze the headstamp to determine whether the scratches are aligned, and whether the scratches show similar features not common to other firearms. Without proper alignment of the cartridge casings, this work is difficult or impossible.

FIG. 7B shows two images 730, 740 of cartridge casing heads, or cartridge casings, aligned for comparison. The image 730 may be a reference image, e.g., from the forensic evidence database 120. The image 740 may be an image of a cartridge casing collected in the field. Regardless of the orientation at which the image 740 was initially captured, the forensic detection analysis module 119 automatically rotates the image 740 to align with the target orientation, e.g., the orientation of the reference image 730. Thus, the scratch patterns on the headstamps are aligned to show the similarity in striation patterns across the two cartridge casings on either side of a vertical dividing line 725.

The images 730, 740, show cartridge casing heads that were fired by a firearm that uses blowback action. A blowback-action firearm does not produce firing pin aperture shear. With blowback action firearms, toolmark examiners may compare characteristics of the impressions imprinted onto the breechface during the firing process. The impressions are a “minting” of the imperfections on the gun's breech block into the primer surface.

There are many types of breechface marks that can be imparted, including parallel, smooth, granular, cross-hatched, circular, and arched. Each type of breechface mark can be aligned using a different approach. Following is a description of example techniques that can be used for auto-aligning shell images with various common breechface patterns.

In some examples, as shown in FIG. 7B, breechface marks can appear as parallel, linear striations. These patterns can be caused by regular horizontal sanding of the breech block. The forensic detection analysis module 119 can detect the striations and orient the striations at the target orientation, e.g., horizontally. This results in parallel breechface marks running from left to right, e.g., 9 o'clock to 3 o'clock.

In some examples, breechface marks can appear as smooth breechface patterns. A smooth breechface pattern might include no visible markings, or very few visible markings. These patterns can be caused by polishing of the breech block. Breechface patterns that are smooth have minimal tell-tale signs. To align an image of a shell with a smooth breechface pattern, the forensic detection analysis module 119 can determine the predominant aspect ratio weighting of the center of the firing pin aperture impression. The forensic detection analysis module 119 can arrange the image such that that the central axis of the impression mark runs extends in the direction of the target orientation, e.g., horizontally with respect to the clock face.

FIGS. 7C to 7F show example firearm cartridge casing heads exhibiting other possible breechface patterns. In some examples, breechface marks can appear as granular breechface patterns, as shown in FIG. 7C. Granular patterns can be caused by sand-blasting of the breech block. To align an image of a shell with a granular breechface pattern, the forensic detection analysis module can align the cartridge casing image such that the centroid of the region of the granular markings with the largest geometric footprint on the breechface is arranged at the target orientation. For example, referring to FIG. 7C, granular markings 702 having the largest geometric footprint are arranged at a horizontal target orientation of 3 o'clock.

In some examples, breechface marks can appear as crosshatch breechface patterns, as shown in FIG. 7D. Crosshatch breechface patterns can be caused by sanding of the breech block with some irregularity in sanding stroke. To align an image of a shell with a crosshatch breechface pattern, the forensic detection analysis module 119 can identify the median, or most common, linear imprint direction of the marks. The forensic detection analysis module 119 can then align the median imprint direction with the target orientation. For example, referring to FIG. 7D, the median imprint direction of the marks 704 are arranged at a horizontal target orientation of 3 o'clock.

In some examples, breechface marks can appear as circular breechface patterns, which can include concentric circles, as shown in FIG. 7E. Circular breechface patterns can be caused by rotary sanding of the breech block. To align an image of a shell with a circular breechface pattern, the forensic detection analysis module 119 can identify the region of the breechface where the concentric circular breechface pattern has the highest spatial density, e.g., the tightest marks and/or the highest abundance of marks. The region with the tightest marks and/or highest abundance of marks can be positioned at the target orientation. For example, referring to FIG. 7E, the region 706 of the breechface with the highest spatial density of markings is arranged at a vertical target orientation of 12 o'clock.

In some examples, breechface marks can appear as arched breechface patterns, as shown in FIG. 7F. Arched breechface patterns can be caused by milling of the breech block. To align an image of a shell with an arched breechface pattern, the forensic detection analysis module 119 can identify a direction of the apex of the arch patterns. The direction of the apex of the arch patterns can be positioned at the target orientation. For example, referring to FIG. 7F, the apex 708 of the arch pattern is arranged at a vertical target orientation of 12 o'clock.

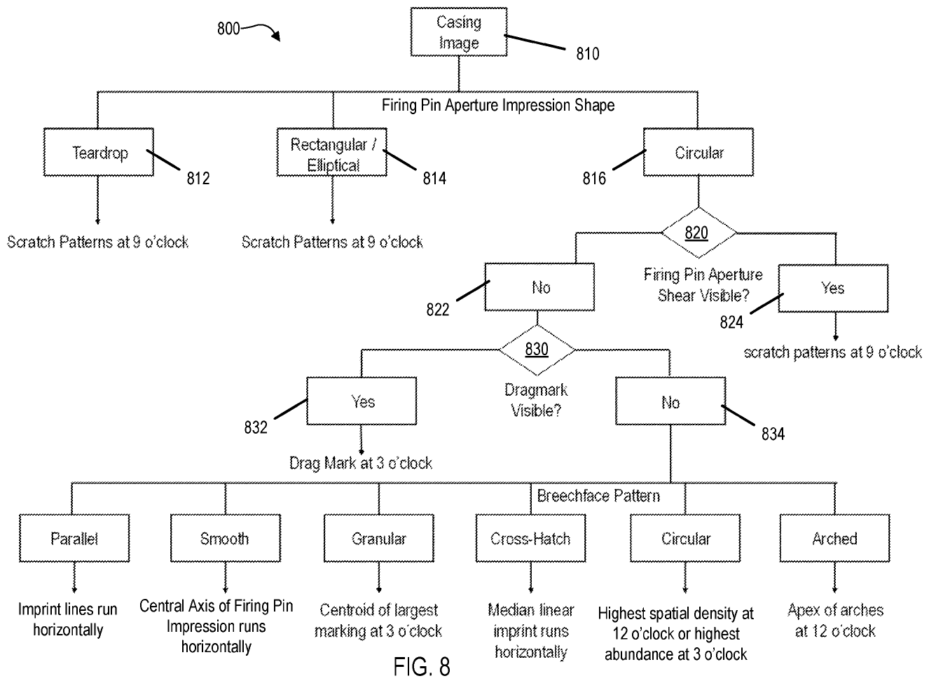

FIG. 8 is a flow diagram of an example process 800 for aligning an image of a firearm cartridge casing head. The process 800 can be performed by a computing system, e.g., the user device 108 or the forensic detection analysis module 119 of the server 117. In general, the forensic detection analysis module 119 performs an automated process to align images using pattern recognition. The forensic detection analysis module 119 uses non-neural network-based computer vision techniques and/or artificial intelligence/machine learning techniques (e.g., generative artificial intelligence) to determine a target orientation for an image of a cartridge casing, and to rotate the image to the target orientation. Techniques such as auto-thresholding and pattern-matching can be used to identify and locate key features of an image. The image can then be rotated to position the key features at the target orientation.

In some implementations, an alignment model is trained to align cartridge casings captured in images to a target orientation. The alignment model can be a machine learning model such as a neural network model, for example, resnet 50. The alignment model can be trained using supervised or unsupervised training methods. In some examples, the alignment model is trained with training data including sets of digital images of firearm cartridge casing heads aligned at target orientations. In the example of FIG. 8, the target orientation is generally described as being horizontal. However, the horizontal orientation (e.g., of 3 o'clock) is included in this description as a reference angle. Any target angle or orientation can be used in the implementation of the disclosed techniques. In some implementations, the forensic detection analysis module 119 can determine a target orientation based on the target orientation of a cartridge casing in a reference image to which a casing image is to be compared.

Referring to FIG. 8, a casing image 810 is obtained, e.g., as described with reference to FIG. 1. The forensic detection analysis module 119 analyzes the casing image 810 to identify a firing pin aperture impression shape. Based on identifying a teardrop shape (812) or a rectangular/elliptical shape (814), the forensic detection analysis module 119 rotates the image so that the longer side of the impression is aligned with the target orientation (e.g., horizontal). If scratch patterns are visible (e.g., due the firing pin aperture shear), the forensic detection analysis module 119 rotates the image to position the scratch patterns at 9 o'clock. If the drag mark is visible, the forensic detection analysis module 119 rotates the image to position the drag mark at 3 o'clock.

Based on identifying a circular firing pin aperture impression shape (816), the forensic detection analysis module 119 determines whether firing pin aperture shear is visible (820). In response to determining that the firing pin aperture shear is visible (824), the forensic detection analysis module 119 rotates the image such that the scratch patterns are at 9 o'clock. If the drag mark is visible, the forensic detection analysis module 119 rotates the image such that the drag mark is at 3 o'clock.

In response to determining that the firing pin aperture shear is not visible (822), the forensic detection analysis module 119 determines whether the drag mark is visible (830). In response to determining that the drag mark is visible (832), the forensic detection analysis module 119 rotates the image such that the drag mark is at 3 o'clock.

In response to determining that the drag mark is not visible (834), the forensic detection analysis module 119 identifies a breechface pattern of the casing. As discussed above with reference to FIGS. 7B to 7F, the breechface pattern can be parallel, smooth, granular, cross-hatch, circular, or arched.

Based on detecting a parallel pattern, the forensic detection analysis module 119 rotates the imprint lines to run horizontally, e.g., between 9 o'clock and 3 o'clock. Based on detecting a smooth pattern, the forensic detection analysis module 119 determines if there is a predominant aspect ratio (e.g., width to height ratio) of the center of the firing pin aperture impression. The forensic detection analysis module 119 rotates the image such that the central axis of the firing pin impression aligns horizontally with respect to the reference axes (e.g., the clock face) in accordance with its predominant aspect ratio, for example, with the long side running horizontally with respect to the reference axes.

Based on detecting a granular pattern, the forensic detection analysis module 119 identifies granular markings having the largest geometric footprint on the breechface and locates a centroid of the region. The forensic detection analysis module 119 rotates the image such that the centroid of the region with the largest footprint is at 3 o'clock of the reference clock face. Based on detecting a cross-hatch pattern, the forensic detection analysis module 119 determines the median, or most common, linear imprint direction of the impression marks. The forensic detection analysis module 119 rotates the image such that the median linear imprint direction runs horizontally with respect to the reference clock face.

Based on detecting a circular pattern, the forensic detection analysis module 119 identifies a region of the concentric circles having the highest spatial density and/or highest abundance of marks. The forensic detection analysis module 119 rotates the image such that the region with the highest spatial density and/or highest abundance of marks is at 12 o'clock. Based on detecting an arched pattern, the forensic detection analysis module 119 identifies a direction of an apex of the arched pattern. The forensic detection analysis module 119 rotates the image such that the apex of the arched pattern is at 12 o'clock of the reference clock face.

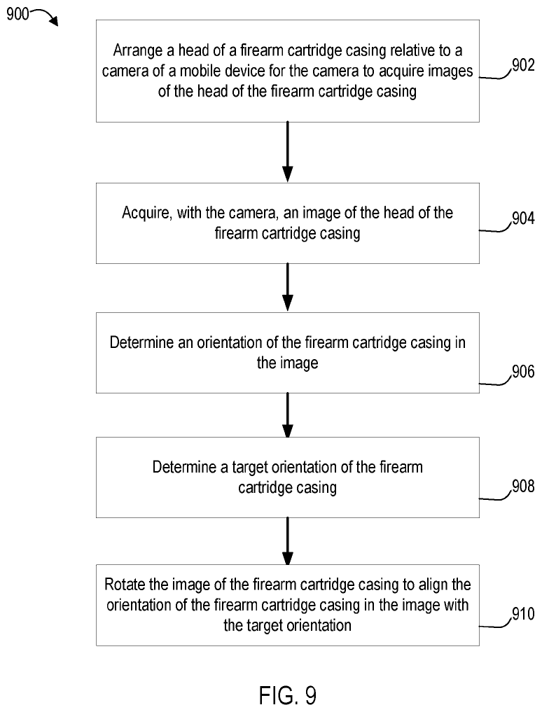

FIG. 9 is a flow diagram of an example process 900 for aligning images of a cartridge casing using forensic imaging apparatus 102. After retrieval of the casing, the head of the casing is arranged in the forensic imaging apparatus with the apparatus mounted to the user device. This positions the sample relative to the camera of the user device for the camera to acquire images of the head of the casing (step 902). For example, the firearm cartridge casing 109 can be positioned within the barrel 101 of the housing 104 and aligned with axis 111 such that the head of the casing 109 is positioned at illumination plane 306.

At this position, the head of the firearm cartridge casing 109 can be in focus by internal camera 118 of the user device so that the user device can acquire high resolution digital images of the head.

Once the casing is properly positioned in the apparatus, the user initiates an image capture sequence to obtain at least one image of the head of the firearm cartridge casing (step 904). Forensic imaging application 116 can have access to an internal camera 118 of user device and provide acquisition instructions to the internal camera 118 as well as illumination instructions to the forensic imaging apparatus 102 to illuminate a particular light source. The acquired image or images can be provided to a forensic detection analysis module 119 on a cloud-based server 117 via network 115.

The forensic detection analysis module 119 determines an orientation of the firearm cartridge casing in the image (step 906). For example, the forensic detection analysis module 119 can use non-neural network-based computer vision techniques and image processing techniques to identify markings on the firearm cartridge casing head. The computer vision techniques can include, for example, object recognition, shape recognition, pattern recognition, object classification, or any combination of these. The markings can include firing pin aperture impressions, firing pin aperture shear, drag marks, and breechface patterns. The forensic detection analysis module 119 can determine an orientation of the firearm cartridge casing in the image with respect to reference axes, e.g., as defined by a clock face, based on the identified markings.

The forensic detection analysis module 119 determines a target orientation of the firearm cartridge casing (step 908). In some examples, the forensic detection analysis module 119 can store data defining standard or default target orientations for firearm cartridge casings. For example, for images in which a drag mark is visible, the default target orientation may be horizontal, with the drag mark at 3 o'clock of the reference clock face.

In some examples, the forensic detection analysis module 119 can determine a target orientation based on a reference image, e.g., based on an orientation of a cartridge casing captured in the reference image. For example, the forensic detection analysis module 119 can access a reference image from the forensic evidence database 120, where the reference image includes a reference firearm cartridge casing having a vertical orientation, with firing pin aperture shear at 6 o'clock with respect to a reference clock face. The forensic detection analysis module 119 can therefore determine a matching target orientation for the acquired image, with the firing pin aperture shear of the bullet cartridge casing at 6 o'clock, in order to compare the acquired image to the reference image.

The forensic detection analysis module 119 rotates the image of the firearm cartridge casing to align the orientation of the firearm cartridge casing in the image with the target orientation of the reference firearm cartridge casing in the reference image (step 910). For example, the orientation of the drag mark in the acquired image may be at 5 o'clock with respect to the reference clock face. The target orientation may be horizontal, with the drag mark at 3 o'clock. The forensic detection analysis module 119 therefore rotates the acquired image counter-clockwise to position the drag mark of the cartridge casing at 3 o'clock to align with the reference firearm cartridge casing of the reference image.

In some examples, the forensic detection analysis module 119 determines a difference between an angle of the target orientation and an angle of the orientation of the acquired image. The forensic detection analysis module 119 can then rotate the acquired image by the difference angle in order to align the acquired image with the target orientation. For example, the target orientation of the cartridge casing may have an apex of an arched pattern at 12 o'clock, or ninety degrees from horizontal with respect to a reference clock position. The apex of the arched pattern in the cartridge casing in the acquired image may be at sixty degrees from horizontal with respect to the reference clock face. The forensic detection analysis module 119 can therefore determine to rotate the acquired image by thirty degrees in order to align the cartridge casing of the acquired image with the target orientation of the cartridge casing in the reference image.

In situations in which the systems discussed here collect personal information about users, or may make use of personal information, the users may be provided with an opportunity to control whether applications or features collect user information (e.g., information about a user's social network, social actions or activities, profession, a user's preferences, or a user's current location), or to control whether and/or how to receive content that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Examples of the subject matter and the operations described in this specification can be implemented in digital electronic circuitry, or in computer software, firmware, or hardware, including the structures disclosed in this specification and their structural equivalents, or in combinations of one or more of them. Examples of the subject matter described in this specification can be implemented as one or more computer programs, i.e., one or more modules of computer program instructions, encoded on computer storage medium for execution by, or to control the operation of, data processing apparatus.

Non-transitory computer-readable storage media can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, examples of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Examples of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network 115 (“LAN”) and a wide area network 115 (“WAN”), an inter-network 115 (e.g., the Internet), and peer-to-peer networks (e.g., ad hoc peer-to-peer networks).

The computing system can include users and servers. A user and server 117 are generally remote from each other and typically interact through a communication network. The relationship of user and server 117 arises by virtue of computer programs running on the respective computers and having a user-server 117 relationship to each other. In some examples, a server 117 transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any features or of what may be claimed, but rather as descriptions of features specific to particular examples. Certain features that are described in this specification in the context of separate examples can also be implemented in combination in a single embodiment. Conversely, various features that are described in the context of a single embodiment can also be implemented in multiple examples separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

Thus, particular examples of the subject matter have been described. Other examples are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1-31. (canceled)

32. A computer-implemented method comprising:
obtaining a candidate image, the candidate image comprising a portion of a bullet shell casing including a plurality of features identifying of a firing process of a specific firearm that fired a bullet including the bullet shell casing;
determining, for the candidate image, a rotation angle to rotate the candidate image to align the portion of the bullet shell casing with a target orientation, wherein the determining comprises:
identifying, in the candidate image, a first feature of the plurality of features comprising a firing pin aperture impression on the bullet shell casing;
determining, for the identified firing pin aperture in the candidate image, a shape of a plurality of shapes of the firing pin aperture impression;
in response to determining that the firing pin aperture impression has a first shape of the plurality of shapes, selecting a first rotation angle to rotate the candidate image of the bullet shell casing to align the firing pin aperture impression with a first target orientation for the first shape;
in response to determining that the firing pin aperture impression has a second, different shape of the plurality of shapes, selecting a second rotation angle to rotate the candidate image of the bullet shell casing to align the firing pin aperture impression with a second target orientation for the second shape;
rotating the candidate image by the rotation angle comprising either the selected first rotation angle or the selected second rotation angle to produce a rotated candidate image; and
providing the rotated candidate image.

33. The computer-implemented method of claim 32, wherein determining the shape of the plurality of shapes of the firing pin aperture impression comprises
determining that the shape of the firing pin aperture impression comprises one of a teardrop shape, rectangular or elliptical shape, or circular shape.

34. The computer-implemented method of claim 32, wherein rotating the candidate image by the rotation angle comprises:
rotating the candidate image such that a central axis of the firing pin aperture impression aligns horizontally with respect to a set of reference axes and in accordance with a predominant aspect ratio of the firing pin aperture impression.

35. The computer-implemented method of claim 32, wherein selecting the first rotation angle to rotate the candidate image of the bullet shell casing to align the firing pin aperture impression with the first target orientation comprises:
selecting a target orientation of a firing pin aperture impression having the first shape on a reference bullet shell casing of a reference image.

36. The computer-implemented method of claim 32, wherein the first rotation angle and the second rotation angle are different.

37. The computer-implemented method of claim 33, wherein, in response to determining the firing pin aperture impression has the second shape of the plurality of shapes, the method further comprises:
determining whether a second feature of the plurality of features identifying of the firing process of a specific firearm that fired the bullet shell casing is present in the candidate image;
in response to determining the second feature of the plurality of features identifying of the firing process of a specific firearm that fired the bullet shell casing is present in the candidate image, selecting a third rotation angle to rotate the candidate image of the bullet shell casing to align the second feature at a third orientation with a third target orientation for the second feature; and
in response to determining the second feature of the plurality of features identifying of the firing process of a specific firearm that fired the bullet shell casing is not present in the candidate image:
determining whether a third feature of the plurality of features identifying of the firing process of a specific firearm that fired the bullet shell casing is present in the candidate image;
in response to determining the third feature of plurality of features is present in the candidate image, selecting a fourth rotation angle to rotate the candidate image of the bullet shell casing to align the third feature at a fourth orientation with a fourth target orientation for the third feature; and
in response to determining the third feature of the plurality of features is not present in the candidate image:
identifying a fourth feature of the plurality of features identifying of the firing process of a specific firearm that fired the bullet shell casing in the candidate image;
determining one or more characteristics of a plurality of characteristics present in the fourth feature; and
selecting, using the one or more characteristics present in the fourth feature, a fifth rotation angle to rotate the candidate image of the bullet shell casing to align the fourth feature at a fifth orientation with a fifth target orientation for the fourth feature.

38. The computer-implemented method of claim 37, wherein the second feature comprises a scratch pattern characteristic of a firing pin aperture shear, the third feature comprises one or more drag marks, and wherein the fourth feature comprises one or more breechface patterns.

39. The computer-implemented method of claim 38, wherein, in response to determining that the shape of the firing pin aperture impression comprises one of teardrop shape, or rectangular or elliptical shape, rotating the candidate image such that an elongated length of the firing pin aperture impression is aligned with the target orientation.

40. The computer-implemented method of claim 39, wherein, in response to further determining that the second feature comprising a scratch pattern is present, rotating the candidate image such that the scratch pattern is oriented at a target orientation.

41. The computer-implemented method of claim 40, wherein, in response to further determining that the second feature comprising the scratch pattern is not present, and in response to further determining that the third feature comprising the drag marks is present, rotating the candidate image such that the one or more drag marks are oriented at a target orientation.

42. The computer-implemented method of claim 38, wherein, in response to determining that the shape of the firing pin aperture impression comprises the circular shape, and further in response to determining that the second feature comprising a scratch pattern is present:
rotating the candidate image such that the scratch pattern is oriented at a target orientation.

43. The computer-implemented method of claim 38, wherein, in response to determining that the shape of the firing pin aperture impression comprises the circular shape, and further in response to determining that the second feature comprising the scratch pattern is not present, and further in response to determining that the third feature comprising the one or more drag marks are present:
rotating the candidate image such that the one or more drag marks are oriented at a target orientation.

44. The computer-implemented method of claim 38, wherein, in response to determining that the shape of the firing pin aperture impression comprises the circular shape, and further in response to determining that the second feature comprising the scratch pattern is not present, and further in response to determining that the third feature comprising the one or more drag marks are not present:
determining the one or more characteristics of the breechface patterns; and
rotating the candidate image to a target orientation in response to the one or more characteristics of the breechface patterns.

45. The computer-implemented method of claim 44, wherein determining the one or more characteristics of the breechface patterns comprises determining one or more patterns including one or more of parallel, smooth, granular, cross-hatch, circular, and arched patterns, and
wherein selecting, using the characteristics of the one or more breechface patterns, the fifth rotation angle to rotate the candidate image of the bullet shell casing to align the one or more breechface patterns at the fifth orientation with the fifth target orientation for the one or more breechface patterns comprises:
selecting a fifth rotation angle in response to the characteristics of the one or more breechface patterns being a first pattern, wherein the selected fifth rotation angle is different than a fifth rotation angle in response to the characteristics of the one or more breechface patterns being a second pattern.

46. The computer-implemented method of claim 45, wherein determining the one or more patterns of the one or more breechface patterns comprises:
determining the one or more patterns comprises a parallel pattern, and wherein selecting the fifth rotation angle comprises:
identifying parallel striations of the parallel pattern; and
rotating the candidate image to orient the parallel striations with the target orientation, wherein rotating the candidate image to orient the parallel striations comprises:
rotating the candidate image to a first orientation to align the parallel striations at 0 degrees to produce a first rotated candidate image and to a second orientation to align the parallel striations at 180 degrees to produce a second rotated candidate image.

47. The computer-implemented method of claim 45, wherein determining the one or more patterns of the one or more breechface patterns comprises:
determining the one or more patterns comprises a smooth pattern, and wherein selecting the fifth rotation angle comprises:
identifying a predominant aspect ratio weighting of a center of the firing pin aperture impression; and
rotating the candidate image such that a central axis of the firing pin aperture impression extends in a direction of the target orientation.

48. The computer-implemented method of claim 45, wherein the one or more patterns of the breechface pattern comprises a granular pattern, and wherein selecting, the fifth rotation angle comprises:
identifying, granular markings having the largest geometric footprint on the breechface pattern;
locating a centroid of a region including the granular pattern; and
rotating the candidate image such that the centroid of the region with the largest geometric footprint is at 3 o'clock.

49. The computer-implemented method of claim 45, wherein the one or more patterns of the breechface pattern comprises a cross-hatched pattern, and wherein selecting, the fifth rotation angle comprises:
identifying, a plurality of marks comprising the cross-hatched pattern;
identifying, one of a median, or most common linear imprint direction of the plurality of marks; and
aligning the linear imprint direction with the target orientation.

50. The computer-implemented method of claim 45, wherein determining the one or more patterns of the one or more breechface patterns comprises:
determining the one or more patterns comprises a circular pattern, and wherein selecting the fifth rotation angle comprises:
identifying a region of the breechface pattern where the circular pattern has a highest spatial density of marks; and
rotating the candidate image to orient the region having the high spatial density of marks with the target orientation.

51. The computer-implemented method of claim 45, wherein determining the one or more patterns of the one or more breechface patterns comprises:
determining the one or more patterns comprises an arched pattern, and wherein selecting the fifth rotation angle comprises:
identifying a direction of an apex of the arch pattern; and
rotating the candidate image to orient the direction of the apex of the arch pattern with the target orientation.

52. The computer-implemented method of claim 32, wherein rotating the candidate image by the first rotation angle or the second rotation angle to produce the rotated candidate image comprises:
rotating the candidate image to align the firing pin aperture impression in the candidate image with the firing pin aperture impression of a reference bullet shell casing in a reference image.

53. The computer-implemented method of claim 32, wherein obtaining the candidate image comprises:
obtaining a candidate image of a head of the bullet shell casing captured by a camera of a user device with the bullet shell casing head being held in a fixed position relative to the camera of the user device during capture of the candidate image.

54. The computer-implemented method of claim 32, wherein obtaining the candidate image of a portion of a bullet shell casing comprises
obtaining a plurality of candidate images capturing respective portions of a plurality of bullet shell casings, wherein an orientation of a head of a bullet shell casing a first candidate image comprises a different orientation than at least one other head of a bullet shell casing in a second candidate image of the plurality of candidate images, and
wherein providing the rotated candidate image comprises
providing a plurality of rotated candidate images, each head of a respective bullet shell casing in a rotated image of the plurality of rotated candidate images being aligned along a same orientation.

55. The computer-implemented method of claim 32, further comprising:
training a machine-learning model, the training comprising:
providing, to a machine-learning model, a plurality of images including respective portions of bullet shell casings, the plurality of images capturing portions of bullet shell casings including the plurality of features having respective characteristics and aligned at respective target orientations,
wherein determining, for the candidate image, the rotation angle to rotate an orientation of the candidate image to align the portion of the bullet shell casing with the target orientation comprises:
providing the candidate image to a trained machine-learned model; and
obtaining, from the trained machine-learned model, the rotation angle to rotate the orientation of the candidate image to align the portion of the bullet shell casing with the target orientation.

56. The computer-implemented method of claim 32, further comprising
determining that the firing pin aperture impression resides on an outer rim of the bullet shell casing; and
rotating the candidate image to align the firing pin aperture impression on the outer rim of the bullet shell casing with respect to a set of reference axis.

57. The computer-implemented method of claim 56, wherein rotating the candidate image to align the firing pin aperture impression on the outer rim of the bullet shell casing comprises rotating the image to place the firing pin aperture impression on the outer at a 3 o'clock position.

58. A non-transitory computer storage media encoded with computer program instructions that when executed by one or more computers cause the one or more computers to perform operations comprising:
obtaining a candidate image, the candidate image comprising a portion of a bullet shell casing including features identifying of a firing process of a specific firearm that fired a bullet including the bullet shell casing, wherein the features include firing pin aperture impression, scratch patterns, drag mark, and one or more breechface patterns;
determining, for the candidate image, a rotation angle to rotate the candidate image to align the portion of the bullet shell casing with a target orientation using the features identifying of the firing process of the specific firearm that fired the bullet including the bullet shell casing, wherein the determining comprises:
identifying, in the candidate image, a shape of a firing pin aperture impression on the bullet shell casing, comprising:
in response to identifying that the firing pin aperture impression has a teardrop or rectangular/elliptical shape, selecting a first rotation angle to rotate the candidate image of the bullet shell casing to align the scratch patterns with a first target orientation;
in response to determining that the firing pin aperture impression has a circular shape, determining whether a firing pin aperture shear is visible, comprising:
in response to determining the firing pin aperture shear is visible, selecting a second rotation angle to rotate the candidate image of the bullet shell casing to align the scratch patterns at the first target orientation; and
in response to determining the firing pin aperture shear is not visible, determining whether the drag mark is visible, comprising:
in response to determining the drag mark is visible, selecting a third rotation angle to rotate the candidate image of the bullet shell casing align the drag mark with a second target orientation; and
in response to determining the drag mark is not visible:
identifying one or more breechface patterns on the bullet shell casing; and
selecting a fourth rotation angle in response to the one or more breechface patterns to align at least one of the one or more breechface patterns with a respective, third target orientation;
rotating the candidate image by the rotation angle comprising either the selected first rotation angle or the selected second rotation angle to produce a rotated candidate image; and
providing the rotated candidate image.

59. A system comprising:
one or more computers and one or more storage devices on which are stored instructions that are operable, when executed by the one or more computers, to cause the one or more computers to perform operations comprising:
obtaining a candidate image, the candidate image comprising a portion of a bullet shell casing including a plurality of features identifying of a firing process of a specific firearm that fired a bullet including the bullet shell casing;
determining, for the candidate image, a rotation angle to rotate the candidate image to align the portion of the bullet shell casing with a target orientation, wherein the determining comprises:
identifying, in the candidate image, a first feature of the plurality of features comprising a firing pin aperture impression on the bullet shell casing;
determining, for the identified firing pin aperture impression in the candidate image, a shape of a plurality of shapes of the firing pin aperture impression;
in response to determining that the firing pin aperture impression has a first shape of the plurality of shapes, selecting a first rotation angle to rotate the candidate image of the bullet shell casing to align the firing pin aperture impression with a first target orientation for the first shape;
in response to determining that the firing pin aperture impression has a second, different shape of the plurality of shapes, selecting a second rotation angle to rotate the candidate image of the bullet shell casing to align the firing pin aperture impression with a second target orientation for the second shape;
rotating the candidate image by the rotation angle comprising either the selected first rotation angle or the selected second rotation angle to produce a rotated candidate image; and
providing the rotated candidate image.
